(19) United States
(12) Patent Application Publication
(10) Pub. No.: US 2026/0109918 A1
(43) Pub. Date: Apr. 23, 2026

(54) WATER-SOLUBLE POUCHES

(71) Applicant: The Procter & Gamble Company, Cincinnati, OH (US)

(72) Inventors: Miguel BRANDT SANZ, Etterbeek (BE); Kristof Bert DONNE, Antwerp (BE)

(21) Appl. No.: 19/363,723

(22) Filed: Oct. 21, 2025

(30) Foreign Application Priority Data
Oct. 22, 2024 (EP) 24208157.8

(51) Int. Cl. C11D 17/04; B65B 3/02; B65B 7/00; B65B 47/00; B65B 59/00; B65B 65/00; B65D 65/46; B65D 75/32

(52) U.S. Cl. CPC C11D 17/045; B65B 3/02; B65B 7/00; B65B 47/00; B65B 59/00; B65B 65/006; B65D 65/46; B65D 75/327; B65B 2230/02

(57) ABSTRACT

A process for making a water-soluble pouch includes providing a first water-soluble film and conveying it along a first direction, forming a first and a second cavities in the first water-soluble film, and filling the first and second cavities with at least a first and second detergent composition respectively. While forming the first and second cavities, the first cavity is separated from the second cavity by a linking portion along a second direction substantially perpendicular to the first direction. A distance measured along the second direction between any point comprised in the first cavity and any point comprised in the second cavity is at least 0.5 cm. The second cavity has a second maximum length along the first direction and a second maximum width along the second direction. An aspect ratio between the second maximum length and the second maximum width is at least 1:1.

### TECHNICAL FIELD

The present disclosure relates to water-soluble pouches, more particularly to water-soluble pouches as such, to processes of manufacturing water-soluble pouches, to systems for manufacturing water-soluble pouches, and to methods of transforming systems for producing water-soluble pouches into systems for producing water-soluble pouches according to the present disclosure.

### BACKGROUND

Water-soluble pouches are for example vastly used in the field of dishwashing, where each individual pouch is provided as a single-use product for each dishwashing cycle. The water-soluble pouches encapsulate a detergent product with a purposely selected chemical composition. During the process of dishwashing, the water-soluble pouch comes into contact with water, the pouch is dissolved, and the detergent composition contained therein is released, enabling effective cleaning of the dishes.

Similar types of water-soluble pouches could also be used for example in washing machines for washing clothes and other domestic or industrial related areas.

### SUMMARY OF INVENTION

The present invention provides a process for making a water-soluble pouch (P), wherein the process comprises:
providing a first water-soluble film (10);
conveying the first water-soluble film (10) along a first direction (X);
forming a first cavity (11A) and a second cavity (11B) in the first water-soluble film (10);
while forming the first and second cavities (11A, 11B), separating the first cavity (11A) from the second cavity (11B) by a linking portion (12) along a second direction (Y), wherein the second direction (Y) is substantially perpendicular to the first direction (X),
wherein a distance measured along the second direction (Y) between any point comprised in the first cavity (11A) and any point comprised in the second cavity (11B) is at least 0.5 cm,
wherein the first cavity (11A) has a first maximum length (X11A) along the first direction (X) and a first maximum width (Y11A) along the second direction (Y),
wherein the second cavity (11B) has a second maximum length (X11B) along the first direction (X) and a second maximum width (Y11B) along the second direction (Y), and an aspect ratio between the second maximum length (X11B) and the second maximum width (Y11B) is at least 1:1; and
filling the first cavity (11A) and the second cavity (11B) with at least a first detergent composition (13A) and at least a second detergent composition (13B) respectively.

### BRIEF DESCRIPTION OF THE DRAWINGS

FIG. 1 shows an example of a water-soluble pouch comprising two cavities and linking portion and a method of placing the water-soluble pouch in a dispenser drawer, such that one of the cavities is hanging outside of the dispenser drawer.

FIGS. 2 and 2A show examples of an array of water-soluble pouches during an example manufacturing process.

FIG. 3 shows an example of a block diagram of a process for making water-soluble pouches.

FIG. 4 shows a top view of an example of a first-water soluble film extending in XY plane and having a first cavity and a second cavity formed therein, and having a linking portion formed between the first cavity and the second cavity.

FIG. 5 shows an example of a block diagram of a process of sealing the first cavity and the second cavity by a second water-soluble film.

FIG. 6 shows examples of various possible shapes of the first and second cavity in the XY plane.

FIG. 7 illustrates an example of an exact shape of a linking portion formed between a first cavity and a second cavity, the linking portion being represented by a grid-like pattern.

FIG. 8 shows examples of various profiles of the first and second cavities in the ZY plane.

FIG. 9 shows an example configuration of a first cavity and a second cavity which is not according to the present disclosure.

FIG. 10 illustrates how maximum length along a first direction X and maximum width along a second direction are defined in an example.

FIG. 11 shows an example of a block diagram of a process of forming additional water-soluble films and additional cavities.

FIG. 12 shows examples of superposing four water-soluble films.

FIG. 13 shows a comparative example where an additional cavity is formed on the linking portion.

FIG. 14 shows an example of a system for manufacturing a water-soluble pouch.

FIG. 15 shows an example transformation of a system for manufacturing a water-soluble pouch.

FIGS. 16 and 17 show an example water-soluble pouch.

### DETAILED DESCRIPTION

The following description will be focused on using water-soluble pouches in dishwashers. However, the same water-soluble pouches as described below could also alternatively be suitable for use in washing machines designed for washing clothes or other devices where detergent is dissolved in water and used for cleaning.

The use of water-soluble pouches is rather popular among users since they are easy and convenient to use. As the quality of the dishwashing processes is being constantly improved, it has also been found that there exist some limitations of conventional dishwashing techniques which could potentially be addressed and overcome by use of another improved type of water-soluble pouches.

Namely, most of the dishwashing machines employ detergent compositions introduced into a detergent compartment, such as a dispenser drawer. The detergent compositions could be solid, powder, liquid, or a combination thereof, and include chemicals which facilitate effective cleaning of the dishes. Detailed examples of the composition are discussed further below. Prior to the start of an automatic dishwashing cycle, a water-soluble pouch is placed in the dispenser drawer by a user. After inserting the water-soluble pouch, the user closes the dispenser drawer. During a washing cycle, the dispenser drawer can in some examples be flooded/fed with water at will, when it is desired to dispense an amount of detergent in the machine and/or when it is desired to dissolve (at least part of) the water-soluble pouch. The dispenser drawer can in some examples have a lid to assist the discharge of the detergent composition. The lid can be opened to discharge a water-soluble pouch prior to the shell of the water-soluble pouch being dissolved, or to discharge the content of the detergent product after the pouch has (at least in part) dissolved. In other words, when the automatic dishwashing cycle starts the dispenser drawer is closed and, after a pre-determined period of time, the dispenser drawer opens and releases the water-soluble pouch into the washing zone. Since the washing zone receiving the items to be washed is at least partially filled with water, or contains water as droplets, or contains a bottom region filled with water, the water-soluble film of the water-soluble pouch dissolves and releases the detergent composition into the washing zone. Dispensing a specific amount of a specific detergent at appropriate time during a cycle may be challenging.

Before the water-soluble pouch is released into the washing zone, a pre-wash stage of the dishwashing cycle can take place, in order to improve quality and effectiveness of the main-wash stage of the dishwashing cycle. During the pre-wash stage, the water-soluble pouch is generally not yet released into the washing zone, to prevent the detergent from being consumed already at that early stage of the washing cycle. Unless the user intentionally adds a pre-wash product in the machine (separately from the insertion of the pouch), only water is used at that pre-wash stage. If a pre-wash cycle requires a specific intervention by a user, the user may forget or may not see the importance of adding such a pre-wash detergent directly in the washing zone. All users may not be skilled in performing that task and some users may make a mistake and use an inappropriate detergent for the pre-wash stage. Such a process also deprives the benefits of the pouches which are normally understood by the consumer as constituting an all-in-one detergent product. In addition, if a pre-wash detergent is included in a pouch, there is less room for the detergent used for the main washing cycle, and the opening of the drawer will release both detergents at once. The efficiency of the main washing cycle will thus have to be sacrificed for the benefit of the pre-wash cycle. Moreover, if both the pre-wash detergent and the main-wash detergent are built in the same product and added in the dispenser, they are both released during the main wash cycle and as such there is no benefit for the pre-wash cycle as in such case the pre-wash cycle will not include any detergent. Furthermore, if both the pre-wash detergent and the main-wash detergent are built in the same product and the consumer is instructed to place the produced directly in the washing area of the machine such that the product can act during the pre-wash, then there is a problem that all detergent is removed from the washing area of the machine at the end of the pre-wash. Consequently, there is no detergent left present for the main wash. Therefore, there is a need to improve the quality of the pre-wash stage without compromising the main washing cycle and without rendering the overall process cumbersome for the consumer.

The present disclosure provides a solution to the above formulated technical problem by introducing a manufacturing process as well as a water-soluble pouch that provide a user-friendly way to improve the pre-wash stage without compromising the main-wash stage. The innovative concept of the present disclosure makes it possible to introduce detergent compositions through one single unit dose product both in the pre-wash stage and in the main-wash stage of the dishwashing cycle, that is, both before the dispenser drawer opens and after the dispenser drawer opens, without relying on the level of expertise of the user.

The present disclosure thus provides water-soluble pouches having a structure that allows a first portion of the water-soluble pouch to be placed into a dispenser drawer, and that also allows a second portion of the water-soluble pouch to hang outside of the dispenser drawer. The two portions of the water-soluble pouch are connected to each other by a linking portion which can be made of the same water-soluble film as the one used to form the water-soluble pouch. The linking portion is sufficiently wide to enable a first portion of the pouch to be held in the dispenser drawer and a second portion to be outside of the dispenser drawer, as the drawer is closed.

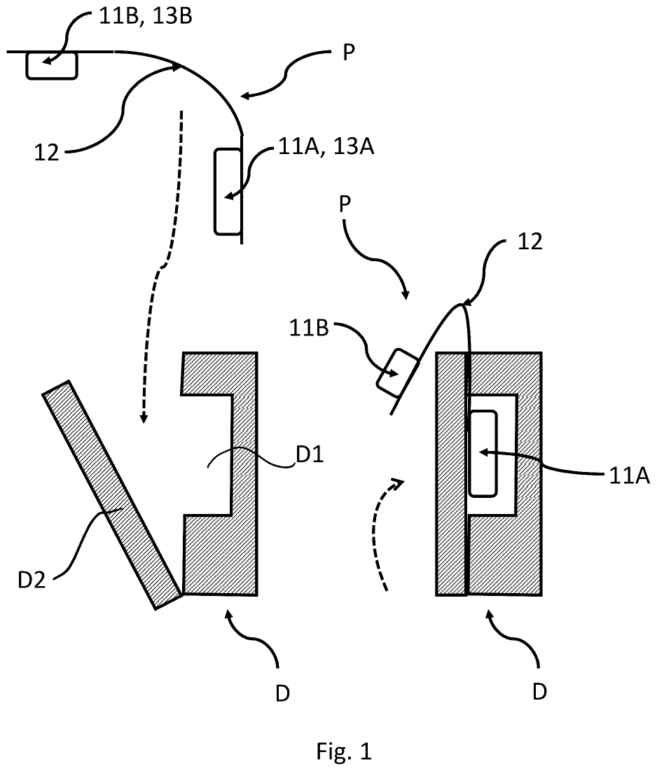

FIG. 1 illustrates an example of such water-soluble pouch P and its placement in a dispenser drawer D. The dispenser drawer D may be fixed to a door of the washing machine. The dispenser drawer D contains a compartment D1 that is reversibly closable by a lid D2. The water-soluble pouch P includes a first cavity 11A containing a first detergent composition 13A and a second cavity 11B containing a second detergent composition 13B. The linking portion 12 is provided between the first cavity 11A and the second cavity 11B. As illustrated in FIG. 1, a portion of the pouch P with the first cavity 11A is intended to be placed in the compartment D1. When the lid D2 of the dispenser drawer D is closed, the first cavity 11A with the first detergent composition 13A is thus inside of the dispenser drawer D and the second cavity 11B with the second detergent composition 13B hangs outside of the dispenser drawer D. The linking portion 12 forms a bridge and enables the second cavity 11B to hang outside while this second cavity 11B still remains part of a single pouch, as the lid D2 is closed.

With the water-soluble pouches P having the above-described structure, a detergent composition 13A contained in the first cavity 11A (the one placed inside of the dispenser drawer) can be dispensed during the main-washing step of the dishwashing cycle, while a detergent composition 13B contained in the second cavity 11B (the one hanging outside of the dispenser drawer D) can be dispensed during the pre-washing step of the dishwashing cycle. This enables a significant improvement in performance of the dishwashing cycle as a whole, since the pre-wash stage of the cycle becomes more effective, without hindering the efficiency of the main-wash cycle and without complexifying the task of the user.

The existing manufacturing techniques currently applied in the conventional systems for manufacturing water-soluble pouches might not be fully appropriate or suitable for manufacturing the above-described water-soluble pouches P having the two detergent-containing portions (the first cavity 11A and the second cavity 11B) separated by the linking portion 12. There is therefore a concomitant need to provide a manufacturing technique for the pouch of the present disclosure and a method for adapting existing manufacturing systems.

The linking portion 12 is aimed at being squeezed in the lid D2 of the dispenser drawer D. In some examples, the linking portion 12 is smooth and thin to ease closure of the lid D2.

In the following paragraphs, it will be assumed that the linking portion 12 is not provided with any detergent-containing cavities.

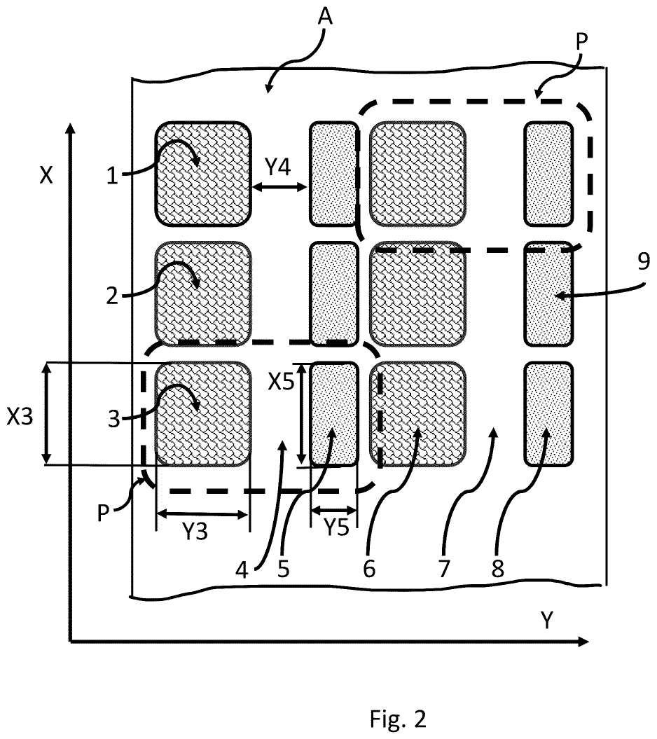

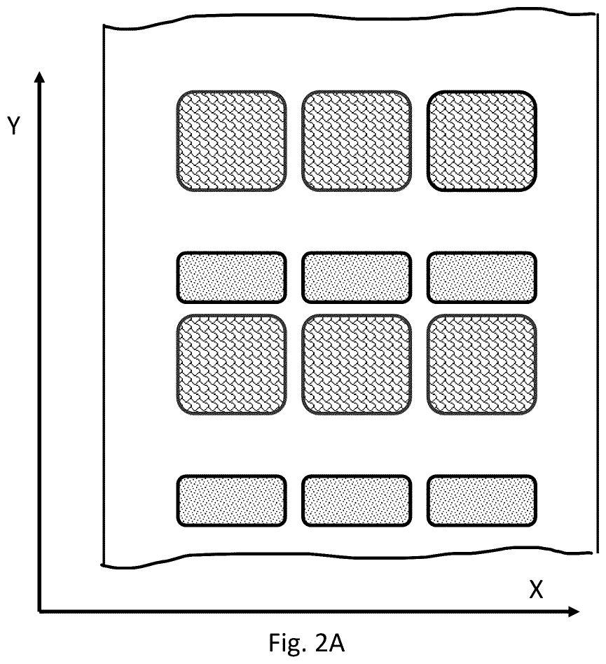

FIG. 2 shows an intermediate product obtained during the manufacturing process of the water-soluble pouches of the present disclosure. FIG. 2 shows a film with an array A of cavities 1-3, 5-6 and 8-9. In this example, a pair of some adjacent cavities is aimed at forming a pouch. Two pouches P are labelled in FIG. 2 by the dashed line. One specific pouch P is formed, once filled and closed, by the cavity 3, by the linking portion 4 and by the cavity 5. The first cavity 3, the linking portion 4 and the second cavity 5 may respectively correspond to the first cavity 11A, the linking portion 12 and the second cavity 11B shown on FIG. 1.

The water-soluble pouches P can be manufactured by unwinding a coil of a film and by conveying the film in a direction. An array A of cavities can be formed along one direction on a conveyor that is equipped with molds or dies. The array A may contain from 1 to ten, or tens or hundreds of rows and may contain for example between 1 and 50 pairs of cavities, more preferably between 3 and 10 pairs. In the examples of FIG. 2 and FIG. 2A, the array A can be conveyed either along the X-direction (see FIG. 2) or along the Y-direction (see FIG. 2A). Reference numbers 1, 2, 3 and 6 in FIG. 2 refer to a first (larger) cavity, reference numbers 5, 8, and 9 refer to a second (smaller) cavity and reference numbers 4 and 7 point to a linking portion between the first and second cavities. In the example of FIG. 2, the detergent composition 13 is fed into the first and second cavities from above by filling heads or nozzles (not shown), that is from the Z-direction, which is perpendicular to both the X-direction and the Y-direction. Directions X, Y and Z form an orthonormal axis system. In other examples, not illustrated here, the first and second cavities of a same pouch may have similar sizes, or the first cavity may be smaller than the second cavity.

For example, the cavities 3 and 5, together with the linking portion 4, are aimed at, once filled and closed, forming an example water-soluble pouch P within the meaning of the present disclosure. Specifically, the cavity 3 is intended to be placed in the dispenser drawer D and may, in some examples, have a size substantially equal to the compartment of the dispenser drawer D, whereas the cavity 5 protrudes outside of the dispenser drawer D. The linking portion 4 bridges the two cavities over the lid D2 of the dispenser drawer D.

The choice of a conveying direction has consequences. Let us consider choosing conveying the film along direction Y. The filling head or nozzle (not shown), which pours the detergent product into cavities, may be at a fixed location. If the conveyor makes the film advance in the direction Y, the filling head/nozzle thus sees, in that order, the cavity 8, the linking portion 7, the cavity 6, the cavity 5, the linking portion 4 and the cavity 3 successively. This means that the filling head successively provides detergent product to a narrow cavity 8, then stops pouring detergent as the linking portion 7 appears, then pours (potentially another) detergent in cavity 6, then interrupt again, and then repeats the process for cavities 5 and 3 and for the linking portion 4. As the filling head/nozzle interrupts the feeding process, the film may advance slower to prevent detergent from being deposited on the linking portion thereby preventing deterioration of seal quality. Depositing detergent on the linking portion is undesirable as it may cause creation of channels in the seal through which the detergent product located in the cavity may leak outside of the cavity or may leak into another cavity. This means that some filling time is wasted (as the filling head passes along direction Y on top of the linking portion) and that the manufacturing process is relatively less efficient.

Moreover, it can be seen that the first cavities 1, 2, 3 and 6 and the second cavities 5, 8, and 9 are, in this example, different. That is, not only the first cavities and the second cavities may have different shapes, but they can also be filled with different detergent compositions. Consequently, if the array of water-soluble pouches P was conveyed along the Y-direction, two feeding mechanisms with different detergent compositions may be provided alternately switch between operation of one feeding mechanism and the other feeding mechanism, or to convey the array of water-soluble pouches first below the first feeding mechanism and then below the second feeding mechanism. The time during which the feeding mechanisms would not be operational would thus be even more increased. Additionally, the number of feeding mechanisms which would have to be used when conveying the array A along the Y-direction would be higher compared to the situation when the array A is conveyed along the X-direction. In the example of FIG. 2, when conveying the array A along the X-direction, only one feeding mechanism is sufficient for each vertical row. That is, one feeding mechanism is used for the vertical row containing cavities 1, 2 and 3, one feeding mechanism is used for the vertical row containing cavity 5, one feeding mechanism is used for the vertical row containing cavity 6 and one feeding mechanism is used for the vertical row containing cavities 8 and 9. In contrast to that, if the direction of conveying of the array A was the Y-direction, two feeding mechanisms would be required for each horizontal row of the array of FIG. 2. That is, two feeding mechanisms would be required for the horizontal row containing the cavity 1, two feeding mechanisms would be required for the horizontal row containing the cavities 2 and 9, and two feeding mechanisms would be required for the horizontal row containing the cavities 3, 5, 6, and 8. Therefore, it can be seen that for the same array A of FIG. 2 the total number of feeding mechanism while conveying the array along the X-direction is four and the total number of feeding mechanisms while conveying the array along the Y-direction is six.

For avoiding deterioration of seal quality of the cavities, and thereby reducing the efficiency of the cleaning process and disturbing the user experience by rendering the handling of the pouch cumbersome for the user, it is therefore beneficial to advance the film along the direction X, i.e., along the direction parallel to the elongated direction of the cavities 5, 8, and/or, in some examples, parallel to the elongated direction of the linking portion.

Indeed, when the array of water-soluble pouches is conveyed along the X-direction, that is essentially in the direction of the cavities 1, 2 and 3, the feeding mechanism could stay operational almost continuously, since the space between two adjacent first cavities 1, 2 and 3 pertaining to different pouches may be reduced compared to a space corresponding to a linking portion of a given pouch. The same could be said about the second cavities 8 and 9. The distances between the second cavities, for example the cavities 8 and 9 pertaining to different pouches, are reduced and thus the feeding mechanism can stay operational without any significant interruptions. That is, when the array of water-soluble pouches is conveyed along the X-direction a larger dosing time window is achieved. Hence, it is possible to obtain an efficient manufacturing process having higher feeding line speeds.

When the conveyor moves the film along the X-direction, it is also clear that a first feeding mechanism could be dedicated to filing the first (larger) cavities 1, 2 and 3 successively, and a second feeding mechanism could be placed in a pre-determined distance (along Y) with respect to the first feeding mechanism and could be dedicated to filling the second (in this example, smaller) cavities 8 and 9. In some examples, no feeding mechanism is placed over the line which is defined by the adjacent linking portions along the X-direction.

To achieve the above stated technical objectives, a distance measured along the Y-direction of FIG. 2 between any point comprised in the first cavity and any point comprised in the second cavity of a same pouch is at least 0.5 cm. In some examples, the distance can be at least 0.7 cm, at least 1 cm, at least 2 cm, at least 5 cm or at least 10 cm. In some examples, the distance can be of less than 20 cm, of less than 15 cm, of less than 10 cm, of less than 7 cm, or of less than 5 cm. Such distance may be reduced to reduce the use of material forming the linking portion. Such distance may be set to a value taking into account a distance to a water filing level in a dishwasher, in order to promote dissolution or to delay dissolution of the second cavity during prewash. The distance is thus selected such that the linking portion is long enough along the Y-direction to enable consumers easily closing the lid of the dispenser drawer D without any complications, and such that, for a given conveyor size, the linking portion is not too large compared to, for example the second cavity 11B, in view of not spilling detergent material outside of the cavity onto the linking portion 12, and using the conveyor space more efficiently. This distance is shown on FIG. 2 as the distance Y4 of the linking portion 4. This distance is sufficient to ensure that there is enough space for the water-soluble pouch to be placed in the dispenser drawer such that the first and second cavities are not squeezed by the lid D2 of the dispenser drawer D. This condition applies to each individual water-soluble pouch, not necessarily for adjacent water-soluble pouches contained in the array of pouches (e.g. cavities 5 and 6 do not need to be distanced from each other by at least 0.5 cm). An example of a single water-soluble pouch in FIG. 2 is a pouch defined by the first cavity 3, the linking portion 4 and the second cavity 5. Another single pouch is defined by points 6, 7 and 8. FIG. 2 includes a number of cavities sufficient to form 6 water-soluble pouches in total.

The second (smaller) cavity 5, 8, 9 may have a shape which is either in a substantially square shape or is elongated in the X-direction of FIG. 2. Other shapes may be considered. For example, X5, the length of the cavity 5 along direction X is greater than Y5, the width of the cavity 5 along the direction Y. While not illustrated here, individual pouches may be obtained by cutting the array such as array A between adjacent pouches, for example between cavities 2 and 3, and between cavities 5 and 6.

In the present disclosure, the “length” is intended to refer to the dimension of an entity along its longest dimension, usually referred to as the first direction, or direction X. The “width” is intended to refer to a dimension of an entity along a second longest dimension, usually perpendicular to the length, and usually referred to as the second direction or direction Y. The “thickness” is intended to refer to the smallest dimension of an entity, usually along the third direction, or direction Z.

The system used to produce the pouch may comprise two pouch-filling lines, with a first and a second cavity-forming devices, arranged adjacent to one another and spaced apart by a minimum distance (Dm on FIG. 17). The cavity-forming devices aim at forming a first cavity (as 11A on FIG. 1 or 1, 2, 3 or 6 on FIG. 2) and forming a second cavity (as cavities 11B on FIG. 1 or 5, 8 or 9 on FIG. 2), respectively. The cavity-forming devices may be such that the second cavity has a maximum width along the direction Y (Y5 on FIG. 2) and the ratio of the maximum width (Y5) over the sum of the minimum distance (Y4) and the maximum width (Y5) is less than 80%:

$$\frac{Y 5}{Y 4 + Y 5} \leq 0.8$$

This ratio enables a zone void of cavities, a.k.a. a linking portion, of a sufficient size between the two cavities to obtain the benefits discussed above.

The present concept may result from adapting an existing manufacturing line. For instance, a non-adapted system produces a first cavity in a first surface area, destinated to form a first pouch, and a second cavity in a second surface area destinated to form a second pouch. Such system is adapted so that the first and second surface area are used to form two cavities of a single pouch according to this disclosure. To that end, the size of the second surface area is comprised between 20 and 80% of the size the first surface area and a minimum distance between a resulting first cavity and a resulting second cavity along a second direction substantially perpendicular to the conveying direction is increased. The present disclosure enables to obtain a water-soluble pouch wherein a distance measured along the second direction Y between any point comprised in the first cavity and any point comprised in the second cavity is at least 0.5 cm; and wherein a second water-soluble film (which is provided to close and seal the cavities, once they have been filled with detergent) may have a substantially planar structure as will be explained in detail below, in the context of FIG. 5 for example.

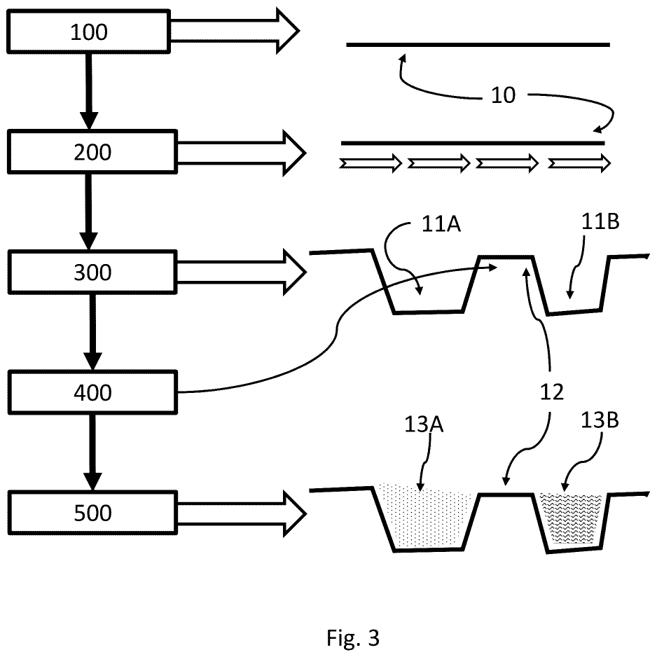

FIG. 3 shows an example of a block diagram of a process for making water-soluble pouches. In the block 100, a first water-soluble film is provided. The first water-soluble film 10 may have a thickness from 20 to 150 micron. The first water-soluble film may be soluble or dispersible in water. The first water-soluble film may have a water-solubility of at least 50% as measured by the method set out here after using a glass-filter with a maximum pore size of 20 microns: 5 grams #0.1 gram of film material is added in a pre-weighed 3 L beaker and 2 L+5 ml of distilled water is added. This is stirred vigorously on a magnetic stirrer, Labline model No. 1250 or equivalent and 5 cm magnetic stirrer, set at 600 rpm, for 30 minutes at 30° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility (or dispersibility) can be calculated.

The first water-soluble film material may be obtained by casting, blow-moulding, extrusion or blown extrusion of a polymeric material, as known in the art, preferably by solvent casting. For example, the first water-soluble film may comprise polyvinylalcohol (PVA) polymer or a polyvinyl alcohol copolymer, or a mixture thereof. Additionally, the first water-soluble film may comprise a non-aqueous plasticizer. The first water-soluble film may also contain a surfactant. The first water-soluble film may additionally comprise lubricants/release agents. The first water-soluble film may also comprise fillers, extenders, antiblocking agents, detackifying agents or a mixture thereof. The first water-soluble film may include a residual moisture content of at least 4%, as measured by Karl Fischer titration.

The first water-soluble film may be provided such that it exhibits water-solubility of at least 50% at temperatures of 24° C. The first water-soluble film may be opaque, transparent or translucent. The first water-soluble film may comprise a printed area, achieved for example by flexographic printing or inkjet printing or other suitable methods.

The first water-soluble film may comprise an aversive agent. The first water-soluble film may be coated in a lubricating agent.

The first water-soluble film 10 may be from a material which can be partially stretched and extended without being broken or torn. Such stretching may cause that some portions of the first water-soluble film become thinner.

One example of a suitable water-soluble film is M8630 as commercially available from the MonoSol company.

In the block 200 of FIG. 3, the first water-soluble film 10 is conveyed along a first direction (X on FIG. 2). For that purpose, any type of conveyor which is capable of moving the first water-soluble film along a substantially straight line is suitable (e.g., endless belt or chain conveyor).

When conveyed, the first water-soluble film may for example extend in a substantially horizontal plane. The width of the first water-soluble film may correspond to the width of the conveyor, where the width of the conveyor is defined as being perpendicular to the direction of conveying. The width of the conveyor could be for example comprised between 10 cm and 200 cm. The width of the conveyor could be constant along the entire length of the conveyor.

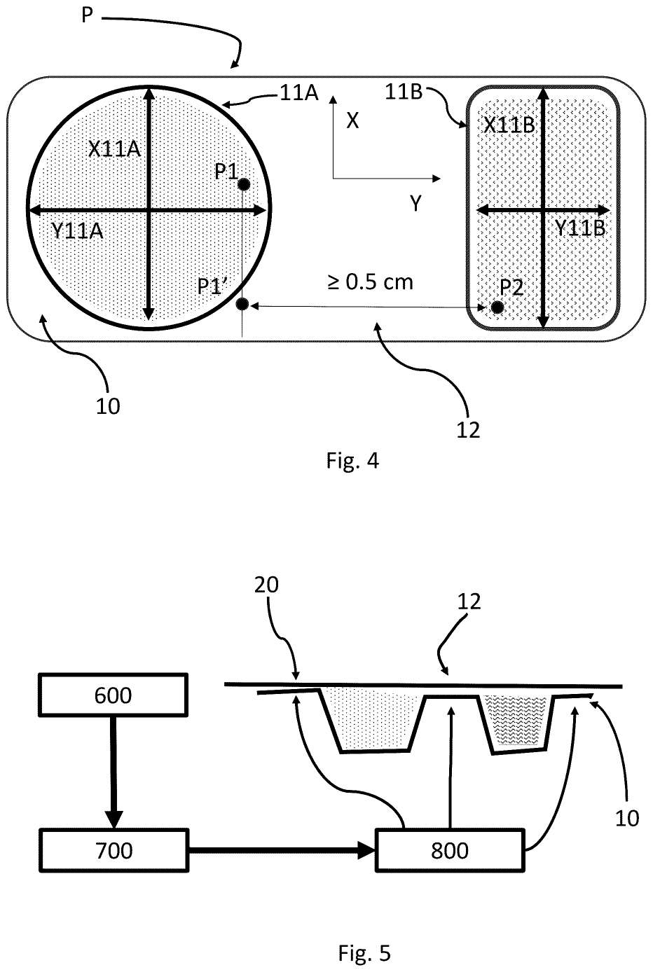

In the block 300 of FIG. 3, a first cavity 11A and a second cavity 11B are formed in the first water-soluble film 10. The cavities 11A, 11B may be formed as the film 10 is being conveyed (i.e., the cavity forming device, or molds are borne by the conveyor). The first and second cavities 11A, 11B may be those of FIG. 1 and/or FIG. 2 for example. The shape of the first and second cavities 11A, 11B can be determined by molds which are pressed onto and through the surface of the first water-soluble film 10, thereby leading to the first water-soluble film 10 to stretch and take the shape of the mold. A vacuum pump may also be used to form the cavities 11A, 11B. The shapes of the first and second cavities 11A, 11B are selected such that the first and second cavities 11A, 11B can be filled with a detergent composition 13A, 13B. The first and second cavities 11A, 11B can have the same shape or a different shape. The shape of the cavities 11A, 11B can vary in the XY plane in which the first water-soluble film 10 extends (see for example FIGS. 4, and 6) and/or can vary in the ZY direction (see for example FIGS. 3 and 8). The first and second cavities 11A, 11B can have different volumes/capacities. For example, the second cavity 11B may have a volume smaller than the volume of the first cavity 11A. Nevertheless, in some examples, the second cavity 11B may have a smaller area in the XY plane compared to the first cavity 11A, while at the same time the second cavity 11B can have a larger volume compared to the first cavity 11A (since the depth of the second cavity 11B along Z direction could be larger than the depth of the first cavity 11A).

In the block 400 of FIG. 3, the first cavity 11A is separated from the second cavity 11B by a linking portion 12 along a second direction Y. This can be done simultaneously to the first and second cavities 11A, 11B are being formed. The second direction Y is substantially perpendicular to the first direction X. That is, the second direction Y is perpendicular to the direction along which the first water-soluble film 10 is moved by the conveyor C. It is also implied that the second direction Y corresponds to the width direction of the conveyor C.

The linking portion 12 is a portion of the first water-soluble film which is located between the first cavity 11A and the second cavity 11B along the second direction Y. However, if a higher number of water-soluble films are present (such as a second, third, fourth or any additional water-soluble film) between the first cavity 11A and the second cavity 11B, then the linking portion 12 also includes portions of these additional water-soluble films which are located between the first cavity 11A and the second cavity 11B. Assuming that the linking portion 12 is extending in the XY plane, the linking portion 12 includes all the points of any water-soluble film, which—for each X coordinate—are located on a line extending along the second direction Y between the point of the first cavity 11A having the highest value of Y coordinate and the point of the second cavity 11B having the lowest value of the Y coordinate.

Separating the first cavity 11A from the second cavity 11B thus means forming the second cavity 11B such that—for at least one X coordinate—the point of the first cavity 11A having the highest value of Y coordinate is separated by a distance of at least 0.5 cm from the point of the second cavity 11B having the lowest value of the Y coordinate.

In the block 500 of FIG. 3, the first cavity 11A and the second cavity 11B are filled with at least a first detergent composition 13A and at least a second detergent composition 13B respectively. In some examples, substantially 100% of the volume of the cavity can be filled by the detergent composition. In other examples, the cavity can be filled up to 90% of its volume, up to 80% of its volume, up to 70% of its volume or up to 50% of its volume. In other examples, if the detergent composition is in the form of a powder the cavities can be slightly overfilled up to 105% of the volume of the cavity, or up to 110% of the volume of the cavity.

The filling operation can be performed by a feeding mechanism, for example a mechanism including a nozzle suitable for discharging a predetermined amount of material. The material can be liquid, powder, or a combination thereof.

The first and second detergent compositions may include detergent ingredients which can be described in terms of systems. The first and second detergent compositions may comprise one or more of an alkalinity system, a bleach system, a builder system, a chelant system, an enzyme system, a polymer system, and a surfactant system. Suitable detergent ingredients can also include other detergent ingredients.

The alkalinity system typically achieves the target pH profile of the detergent composition. The pH profile of the detergent composition impacts the cleaning profile of the detergent composition. Alkalinity typically provides soil swelling and soil dispersion performance, as well as providing the optimal pH for other detergent ingredients to work, such as the bleach system, builder system, chelant system and enzyme system.

Typically, the bleach system provides cleaning and disinfection benefits. Typically, the composition comprises from 0.1 g to 15 g bleach system. The bleach system typically comprises a source of peroxygen, often in combination with a bleach activator and/or a bleach catalyst.

Either one of the first and second detergent compositions may comprise from 1.0 g to 15 g builder system. The builder system typically comprises detergent ingredients that are complexing agents. Suitable builder complexing agents are capable of sequestering hardness cations, especially calcium cations and/or magnesium cations. Typically, the builder system controls the hardness of the wash liquor, which in turn aids the cleaning performance and soil suspension performance of the composition. The builder system can also extract calcium and magnesium cations from the soil, which also improves the cleaning performance of the composition. Any suitable builder complexing agent can be used. Suitable builder complexing agents may also be able to complex other cations, such as transition metal cations. A preferred builder complexing agent is selected from aminopolycarboxylic acids and/or salts thereof, carboxylic acids and/or salts thereof, and any combination thereof.

Either one of the first and second detergent composition may comprise from 0.1 g to 5.0 g of a chelant system. The chelant system typically comprising chelating agents. Suitable chelating agents can chelate transition metal cations, especially copper, iron and zinc. Typically, the chelant system stabilizes the bleaching system by protecting the bleach from transition metal cation degradation. The chelant system can also extract transition metal cations from soils, such as tea soils. Any suitable chelating agent can be used. Suitable chelating agents may also be able to complex other cations, such as hardness cations like calcium and magnesium. Suitable chelating agents are selected from aminophosphonic and/or aminocarboxylic acids and/or salts thereof. Aminophosphonic and/or aminocarboxylic acids and/or salts thereof typically provide crystal growth inhibition performance.

Either one of the first and second detergent compositions may comprise from 1.0 g to 400 mg enzyme system. The enzyme system provides cleaning benefits. The enzyme typically comprises an enzyme selected from amylase, cellulase, lipase, protease, and any combination thereof. Preferably, the enzyme system comprises an amylase and/or a protease. The composition typically comprises, on an active enzyme basis, from 1.0 mg to 300 mg of each enzyme type included in the composition. The composition may comprise, on an active enzyme basis, from 10.0 mg to 300 mg protease and from 2.0 mg to 30 mg amylase.

Either one of the first and second detergent compositions may comprise from 0.1 g to 5.0 g, or from 0.5 g to 2.0 g polymer system. The polymer system can act as soil dispersant as well, as a co-builder to help complex hardness cations such as calcium and magnesium. The polymer system typically comprises polymers. Suitable polymers are selected from modified polyamine polymers, modified polysaccharide polymers, polyalkylene oxide polymers, polycarboxylate polymers, silicone polymers, terephthalate polymers, other polyester polymers, and any combination thereof. Preferably, the polymer system comprises polymers selected from polyamine polymers, modified polysaccharide polymers, polyalkylene oxide polymers, polycarboxylate polymers, and any combination thereof, most preferably, polycarboxylate polymers. The composition may comprise from 0.1 g to 5.0 g, or from 0.5 g to 2.0 g polycarboxylate polymers.

Typically, the surfactant system provides cleaning benefits, shine benefits, water drainage and drying benefits. The surfactant system can act to remove soil and suspend soil. The composition may comprise from 0.5 g to 5.0 g, or from 0.6 g to 4.0 g, or from 0.7 g to 3.0 g surfactant system. The surfactant system can comprise amphoteric surfactant, anionic surfactant, cationic surfactant, nonionic surfactant, zwitterionic surfactant, and any combination thereof. Most preferably, the surfactant system comprises nonionic surfactant. The surfactant system typically comprises a surfactant, typically one or more, preferably two or more, or three or more, or four or more, or even five or more different types of surfactants, and preferably from 2 to 8, or 3 to 7, or 4 to 6 different types of surfactants.

FIG. 4 shows an example of the shapes of the cavities of the pouch. The first cavity 11A has a circular shape in the XY plane and the second cavity 11B has a rectangular shape with rounder edges. However, in other examples, both the first cavity 11A and the second cavity 11B could be provided in circular shapes, or alternatively both the first cavity 11A and the second cavity can be provided in rectangular shapes, or the first cavity 11A could have a rectangular shape and the second cavity 11B can have a circular shape. The shapes of the first and second cavities 11A, 11B are not limited and can be selected to appropriately dispense the detergent during the washing cycle.

FIG. 4 also shows that any point P1 of the first cavity 11A is separated from any point P2 of the second cavity, along the direction Y transverse to the conveying direction, by at least 0.5 cm. This distance enables a smooth and easy positioning of the pouch in the dispenser drawer to ensure an efficient pre-wash without compromising the main-wash cycle and without complexifying the user's task. The point P1′ has the same Y coordinate as P1 and the same X-coordinate as P2.

The correct way of measuring the distance along the second direction Y between any point comprised in the first cavity 11A and any point comprised in the second cavity 11B is illustrated in FIG. 4. As can be seen in FIG. 4, the shapes of the first and second cavities are such that for any randomly chosen point P1 located in the first cavity 11A and for any randomly chosen point P2 of the second cavity, one can see that the distance along Y (i.e. the difference of their Y-coordinates values) is at least 0.5 cm.

FIG. 5 shows a cross-section of the pouch of FIG. 4. Here, a second water-soluble film 20 is shown. The second water-soluble film 20 is provided to close and seal the cavities, once they have been filled with detergent.

Although FIG. 4 shows a second film 20 that is substantially flat and shows cavities which have been filled up to their upper edge, and not more, other arrangements may be considered.

Indeed, the cavities can be over-filled, such that the upper portion of the detergent material forms a convex shape, and such that the second water-soluble film 20, once laid onto the first film and the filled cavities, forms two bulges corresponding to the over-filled cavities. In some examples, the second water-soluble film 20 as illustrated in FIG. 5 may also bulge upwards due to an effect of internal pressure caused by elasticity of the first water-soluble film 10. That is, the bulging and the resulting convex shape of the second-water soluble film 20 may also occur even when the cavities are not over-filled. The cavities may also be under-filled. Different cavities of a same pouch may have different fill levels, for example to adjust a quantity of detergent release in different wash phases.

The second film 20 may be made of a similar water-soluble material as the first film 10.

As illustrated in FIG. 4, the process for making a water-soluble pouch P may comprise a block 600 of providing a second water-soluble film 20 and a block 700 of covering the first water-soluble film 10 with the second water-soluble film 20. A block 800 comprises sealing the filled first cavity 11A and the filled second cavity 11B, by making the first water-soluble film 10 adhere to the second water-soluble film 20.

The second water-soluble film 20 may be provided in any one of the example forms presented above with respect to the first water-soluble film 10. The second water-soluble film 20 may be made of the same material as the first water-soluble film 10. The second water-soluble film may have the same thickness as the first water-soluble film 10. Overall, the first water-soluble film 10 and the second water-soluble film may have the same physical properties. Alternatively, in some examples, the second water-soluble film 20 may be made of a different material than the first water-soluble film 10. The second water-soluble film 20 may have different thickness than the first water-soluble film 10, for example at least 20% thicker, or at least 50% thicker. For example, the second water-soluble film 20 may be thinner than the first water-soluble film 10, for example at least 20% thinner, or at least 50% thinner.

The filled first cavity 11A and the filled second cavity 11B may be closed in various ways. For example, the first-water soluble film 10 in which the first and second cavities 11A, 11B are formed can be cut and rolled so that a portion of the first water-soluble film 10 is used to close the openings of the cavities 11A, 11B, thereby forming a closed pouch.

In other examples, the first and second cavities 11A, 11B may be closed by using a material which is not soluble in water. In other examples, the entity which closes the first and second cavities 11A, 11B is not a film.

Closing and sealing the first and second cavities 11A, 11B by a water-soluble film has an advantage in that the entirety of the resulting pouch is water-soluble. If a first and a second water soluble film are used which are from different rolls, it has an advantage in that it does not require cutting and rolling the first water-soluble film 10 onto itself, which may constitute a complexification of the manufacturing process that could require additional equipment at the manufacturing line. Furthermore, sealing the first-water soluble film 10 with another material in the form of a film improves overall solubility of the resulting product.

FIGS. 6(a) to 6(d) illustrate various other example shapes of the first and second cavities 11A, 11B. The dashed line in FIGS. 6(a) to 6(d) indicates a middle line of the water-soluble pouch in the Y direction. As illustrated, the first and second cavities 11A, 11B can be provided in any regular geometrical shapes as well as in any irregular/random shapes. The choice of the shape may have an informative significance for the user: for example a pouch containing a detergent specific to a particular use (e.g., a hardness of the water, an amount of dirt on the dishes, a specific water temperature, etc.) can have a shape that is identifiable by the user for such a particular use. In addition, the shape of the cavities dictates the way the detergent is released in the washing machine: for example, the content of a wide and thin cavity may be dispensed quicker than the content of a round and thick cavity.

The pouches shown on FIGS. 6(a) to (d) show that any point of the first cavity is distanced from any point of the second cavity by at least a distance (0.5 cm) along the direction Y.

The pouches shown on FIGS. 6(e) and 6(f) do not show such a distance. They illustrate that in such a situation, closing a regular drawer is not possible. Such examples 6(e) and 6(f) are comparative examples which do not permit obtaining the benefits of pouches according to the present disclosure.

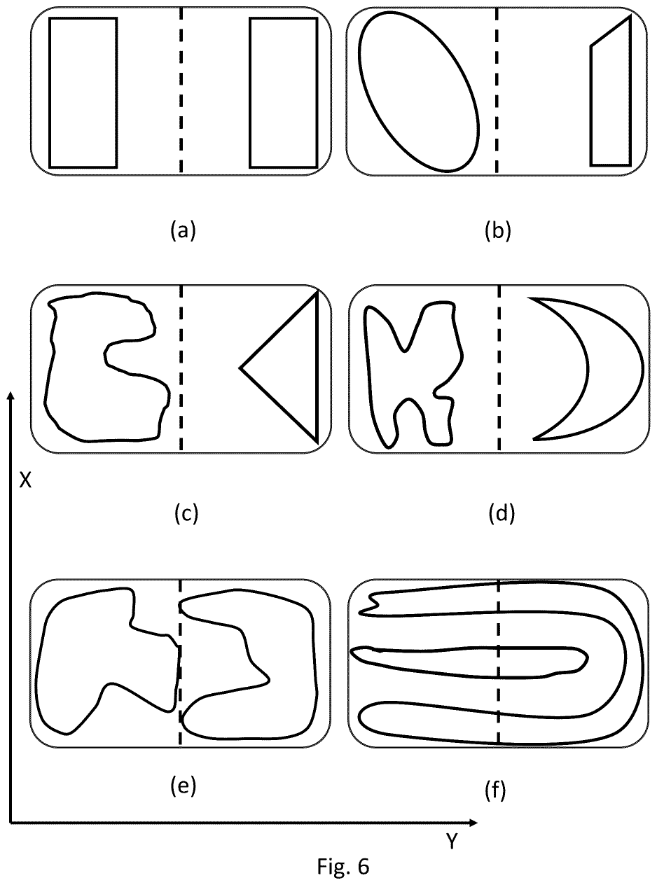

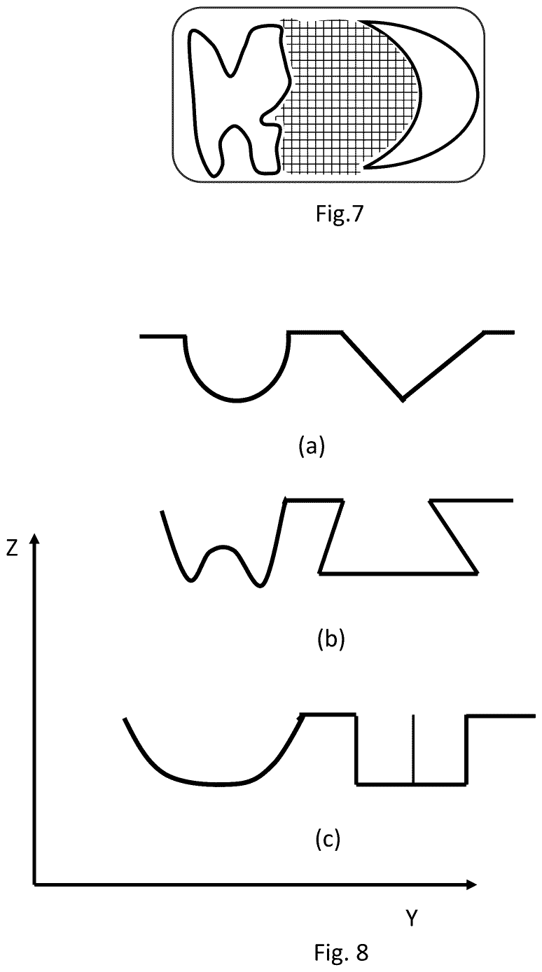

FIG. 7 schematically illustrates an example of a linking portion 12 corresponding to the example shapes of the cavities of FIG. 6(d). In FIG. 7, the linking portion is shown in a grid-like pattern.

A distance measured along the second direction Y between any point comprised in the first cavity 11A and any point comprised in the second cavity 11B is at least 0.5 cm. An advantageous effect of this feature is that the linking portion 12 formed between the pair of cavities includes a strip of water-soluble film(s) extending along the first direction X where no cavity is formed, and where the strip has a width of at least 0.5 cm along the second direction Y for any point at any X coordinate. The presence of such a strip of water-soluble film(s) ensures that there is an area of the water-soluble pouch which is adapted to be squeezed by the lid D2 of the dispenser drawer D. It is thus ensured that a portion of the water-soluble pouch located on one side with respect to the linking portion can be closed in the dispenser drawer while a portion of the water-soluble pouch located on the opposite side with regard to the linking portion is adapted to hang outside of the dispenser drawer.

FIGS. 8(a) to 8(c) illustrate various possible and non-limiting profiles of the first and second cavities 11A, 11B in the cross-section taken in the ZY plane. These various profiles mirror the shape of the molds used to form the cavities. As can be seen in FIG. 8, the depth of the first and second cavities 11A, 11B is defined along the Z direction. The example of FIG. 8(a) shows that the bottom of the first cavity 11A may have a rounded or circular profile. The same profile could be applied to the second cavity 11B. The example of FIG. 8(b) shows that the bottom of the second cavity 11B may have a triangular profile, or rather a V-shaped profile. The same profile could be applied to the first cavity 11A. FIG. 8(b) shows an example of a cavity having a wavy bottom and an example of a cavity having a substantially flat bottom. FIG. 8(c) shows yet another example of a cavity having a rounded bottom.

Furthermore, FIG. 8(c) shows an example of a cavity which is partitioned. Such cavity can thus be formed into two separate compartments. These two separate compartments may include the same or different content. For example, one compartment of the same cavity can include liquid detergent composition, while another compartment of the same cavity can include solid detergent composition. Each one of the first cavity and the second cavity can be divided into two or more compartments, such as three, four or even more compartments. The partition may be along different directions as will be explained below.

It is important to note that the first cavity and the second cavity discussed above and up to here, are intended to mean “at least one” first cavity and “at least one” second cavity. This means that in the overall innovative concept of the present document, one or more cavities are intended to be held in the dispenser drawer, while one or more cavities are intended to hand outside of the dispenser drawer. Any point of any of the one or more first cavities is distanced in the Y direction from any point of any of the one or more second cavities by at least 0.5 cm.

Hence, the number of cavities could be greater than two. At least two cavities are required so that one cavity can contain detergent composition to be used in the pre-wash stage and the other cavity contains detergent composition to be used in the main-wash stage. Two or more cavities could be provided in the first-water soluble film to be used in the pre-wash stage. In the same way, two or more cavities could be provided in the first water-soluble film to be used in the main-wash stage. In an example, the plurality of cavities can be all filled with the same detergent composition. In other examples, each of the plurality of cavities can be filled with different detergent composition. In addition, at least one of the plurality of cavities can be divided into at least two separate compartments.

In general, the cavities are formed for example by molding the first water-soluble film into the desired shape. In contrast, compartments in the cavities can be formed in an additional process of partitioning the space of the cavities into two or more separated areas by using barriers, partition wall as such. In some examples, two or more neighboring cavities can be created, spaced about 3 mm apart to enable an internal seal being created at the separating space into which the film is drawn.

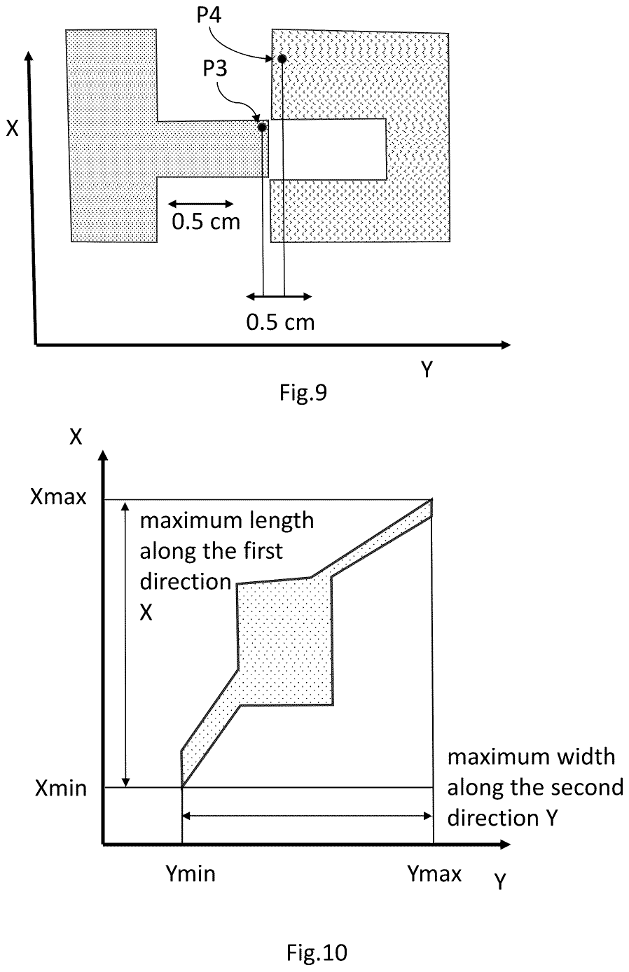

FIG. 9 shows a counter-example, i.e., a pouch with two cavities which does not meet the conditions of the present disclosure. The distance between two randomly chosen points P3, P4 of respective cavities are not separated by at least 0.5 cm.

Regarding the requirement that the distance measured along the second direction Y between any point comprised in the first cavity 11A and any point comprised in the second cavity 11B is at least 0.5 cm, it should be noted that it is not sufficient when for each value of coordinate X, the width of the linking portion 12 along the second direction Y is at least 0.5 cm. As can be seen in FIG. 9, for each value of X the distance between the point of the first cavity having the highest value of Y coordinate is at least 0.5 cm away from the point of the second cavity having the lowest value of Y coordinate. However, this condition does not ensure a presence of a strip of water-soluble film extending along the first direction X and having a width along the second direction Y of at least 0.5 cm. To be even more specific, if a water-soluble pouch having the first cavity 11A and the second cavity 11B in accordance with FIG. 9 were placed in the dispenser drawer such that a portion of the water-soluble pouch would be hanging outside, the lid D2 of the dispenser drawer D would have to squeeze at least some portion of the first cavity 11A or the second cavity 11B. This is because the points P3 and P4 illustrated in FIG. 9 are closer than 0.5 cm when their distance is measured along the second direction Y.

In some examples, the distance measured along the second direction Y between any point comprised in the first cavity 11A and any point comprised in the second cavity 11B can be at least 0.7 cm, at least 1 cm, at least 2 cm, at least 5 cm or at least 10 cm, depending on a specific purpose for which the water-soluble pouch is intended. Different values of the distance measured along the second direction Y between any point comprised in the first cavity 11A and any point comprised in the second cavity 11B may be used for different types of washing machines.

The first cavity 11A has a first maximum length X11A along the first direction X and a first maximum width Y11A along the second direction Y, perpendicular to the first direction X. The width as used in the present description corresponds to a dimension measured along the second direction and the length as used in the present description corresponds to a dimension measured along the first direction. The first direction corresponds to the direction of movement of the conveyor used in the manufacturing process.

The first maximum length X11A along the first direction X is calculated as a difference between a point located in the first cavity 11A and having the highest value of X coordinate, Xmax, of all the points located in the first cavity 11A and a point located in the first cavity 11A and having the lowest value of X coordinate, Xmin, of all the points located in the first cavity 11A. In some cases, more than one point having the value Xmax and more than one point having the value Xmin can exist. Example where only one point having the value Xmax and only one point having the value Xmin exists is illustrated in FIG. 10, the cavity being represented by the greyed out area.

Similarly, the first maximum width Y11A along the second direction Y is calculated as a difference between a point located in the first cavity 11A and having the highest value of Y coordinate, Ymax, of all the points located in the first cavity 11A and a point located in the first cavity 11A and having the lowest value of Y coordinate, Ymin, of all the point located in the first cavity 11A.

The shape of the cavity illustrated in FIG. 10 is intentionally selected to be quite random and is mainly selected to illustrate to way of determining the first maximum width Y11A along the second direction Y and the first maximum length X11A along the first direction X.

The first maximum length X11A and the first maximum width Y11A are parameters defining the first cavity 11A. Analogically, the second cavity 11B has a second maximum length X11B along the first direction X and a second maximum width Y11B along the second direction Y. These parameters are calculated in the same way as those for the first cavity 11A based on the illustration of FIG. 10. Moreover, a first maximum height Z11A and a second maximum height Z11B along the third direction Z are also defined in the same way for the first cavity 11A and the second cavity 11B respectively.

The first maximum length X11A may be in the interval from 1.0 cm to 10.0 cm, in some examples from 2.0 cm to 6.0 cm. The first maximum width Y11A may be in the interval from 1.0 cm to 10.0 cm, in some examples from 2.0 cm to 5.0 cm. The first maximum height Z11A may be in the interval from 1.0 cm to 10.0 cm, in some examples from 1.0 cm to 3.0 cm.

An aspect ratio between the second maximum length X11B and the second maximum width Y11B is at least 1:1. A technical advantage of this feature is that the second cavity 11B is not elongated in the second direction Y. In other words, the second cavity 11B in such examples is elongated in the first direction X, which is the direction of the conveyor movement. This increases efficiency of the feeding mechanisms of the conveyer C such that there are reduced gaps between the second cavities 11B along the first direction X between adjacent pouches P. The feature also has the technical advantage that at least a portion of the linking portion 12 is in the form of an elongated strip extending substantially along the first direction X and having sufficient width along the second direction Y, so that this strip of the linking portion 12 can be squeezed by the lid D2 of the dispenser drawer D without affecting the first and the second cavities 11A, 11B.

In some examples, the aspect ratio between the second maximum length X11B and the second maximum width Y11B may be at least 1.1:1, at least 1.3:1, at least 1.5:1, at least 2:1, at least 2.5:1, or at least 3:1.

The process for making a water-soluble pouch P described above, for example in relation to FIG. 3 and/or FIG. 5 may further comprise dividing at least one of the first cavity 11A and the second cavity 11B into at least two separate compartments. An example of a cavity divided into two compartments is illustrated in FIG. 8(c), where the division into the separate compartments is made along the second direction Y. In other examples, the division into separate compartments can be done substantially along the first direction X. Additionally, the division into separate compartments can be done along both the first direction X and the second direction Y, resulting for example in a set of compartments arranged substantially in a grid. In other examples, dividing a cavity into separate compartments can be done substantially along the third direction Z, meaning that the compartments can be stacked on top of each other. All possible combinations of all the forms of dividing the cavity into compartments as described in the present paragraph are applicable.

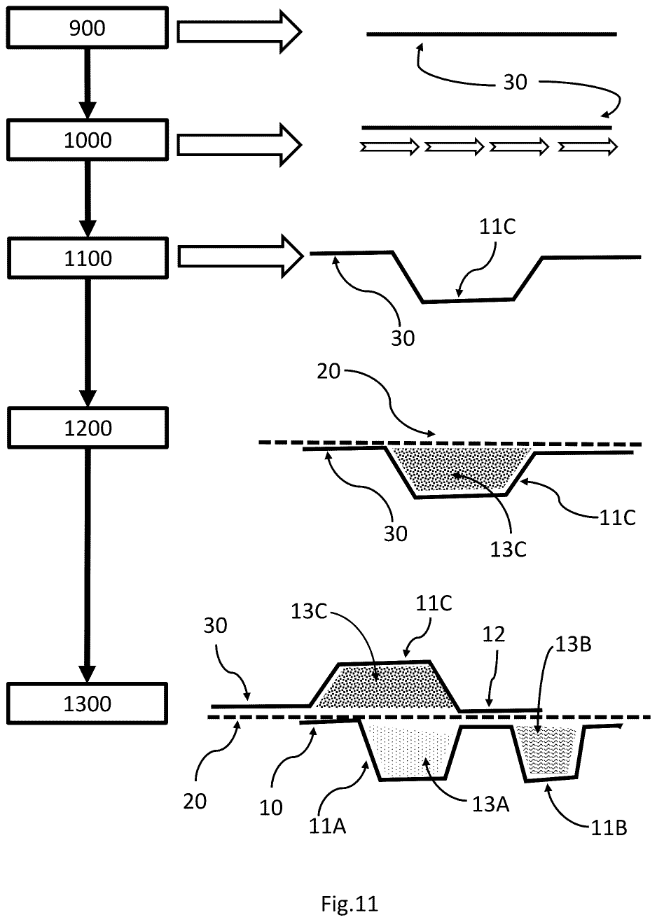

FIG. 11 shows additional blocks (blocks 900-1300) which can be carried out in some examples of the process of the present disclosure.

The process for making a water-soluble pouch P described above, for example in relation to FIG. 3 and/or FIG. 5 may comprise a block 900 of providing one or more additional water-soluble film 30, and/or conveying in block 1000 that one or more additional water-soluble films, and/or forming in block 1100 one or more additional cavity 11C in at least one of the one or more additional water-soluble films, and/or filling and sealing in block 1200 the one or more additional cavity with one or more additional detergent composition 13C, and/or superposing in block 1300 the additional water-soluble films on the first 10 and potentially second 20, or additional, water-soluble films.

The water-soluble pouches P in accordance with the present disclosure include at least one water-soluble film, namely the first water-soluble film 10. The presence of at least one water-soluble film ensures that at least a portion of the final product can be dissolved in water, thereby reliably releasing the detergent composition 13 in the washing zone of a dishwashing machine. The second water-soluble film 20 can be used to further improve the characteristics of the water-soluble pouch P as described above. Nevertheless, the number of water-soluble films used to manufacture the water-soluble pouch P is not limited. Three or more water-soluble films can be used in various mutual spatial configurations.

Each water-soluble film, including the second-water soluble film 20 described above and any other additional water-soluble film, can be provided with one or more cavities formed therein. The first water-soluble film 10 includes at least the first cavity 11A and the second cavity 11B, but can be provided with any number of additional cavities.

As shown on FIG. 11, a third water-soluble film 30 can be provided. The third water-soluble film 30 can be provided in any one of the forms described above for the first water-soluble film 10 and/or the second water-soluble film 20. In some examples, the third water-soluble film 30 can be the same as or different from the first and/or second water-soluble film 10, 20. The third water-soluble film 30 can be conveyed by an additional conveyor, which might be separate from the conveyor used for moving the first water-soluble film 10. A cavity, referred to as a third cavity 11C, can be formed in the third water-soluble film 30, for example by using a cavity-forming device, such as a mold of a predetermined shape. The third cavity 11C can be filled with a third detergent composition 13C. The third detergent composition may be the same as or different from the first and/or second detergent compositions 13A, 13B. The third cavity 11C may be closed and sealed by the second water-soluble film 20, that is by the same film which is also used for closing and sealing the first and second cavities 11A, 11B. The second water-soluble film 20 may be used to cover and seal the first and second cavities 11A, 11B formed in the first water-soluble film 10 in the same way as described with reference to FIG. 5. The second water-soluble film 20 can thus be used to seal all three cavities 11A, 11B, 11C, while the third cavity 11C can be provided on opposite side of the second water-soluble film 20 than the first and second cavities 11A, 11B. In the present example, the linking portion 12 can therefore comprise three superposed water-soluble films 10, 20, 30. The thickness of the linking portion 12 can substantially equal to combined thicknesses of each one of the water-soluble films 10, 20, 30.

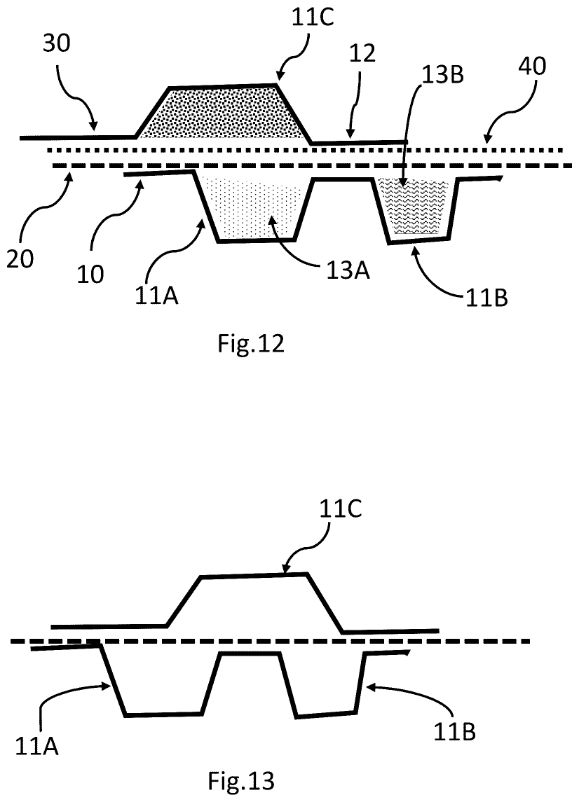

The process for making a water-soluble pouch P described above, for example in relation to FIG. 3 and/or FIG. 5 and/or FIG. 11 may comprise a further block of providing a fourth water-soluble film 40, which may be arranged as depicted in FIGS. 11-12.

The fourth water-soluble film 40 can be provided in any one of the forms described above for the first water-soluble film 10. In some examples, the fourth water-soluble film 40 can be the same as or different from the first, second and/or third water-soluble film 10, 20, 30. The fourth water-soluble film 40 can be used in the process of FIG. 11 instead of the second water-soluble film 20. That is, the fourth water-soluble film 40 may be used for covering and sealing the third cavity 11C formed in the third water-soluble film 30. Accordingly, in the present example, the third cavity 11C may be closed and sealed by a film which is different from the film that is used for closing and sealing the first and second cavities 11A, 11B. The first and second cavities 11A, 11B formed in the first water-soluble film 10 are covered and sealed by the second water-soluble film 20. In the present example, the second and fourth water-soluble films 20, 40 can be superposed on top of each other such that the bottom of the third cavity 11C is opposite to the bottoms of each one of the first and second cavities 11A, 11B. In other words, the third water-soluble film 30 is not in contact with the second water-soluble film 20. The result of such a superposition of four films is shown in FIG. 12. In the example of FIG. 12, the films are provided in the following order, from the bottom to top of FIG. 12: the first water-soluble film 10, the second water-soluble film 20, the fourth water-soluble film 40 and the third water-soluble film 30. In contrast to the example of FIG. 11, the second water-soluble film 20 is not used to cover and seal all three cavities 11A, 11B, 11C. However, in the example of FIG. 12, the third cavity 11C is still provided on opposite side of the second water-soluble film 20 than the first and second cavities 11A, 11B, only with the fourth water-soluble film 40 being interposed between the second water-soluble film 20 and the third water-soluble film 30. In the present example, the linking portion 12 can be formed by four superposed water-soluble films 10, 20, 30, 40. The thickness of the linking portion 12 can be substantially equal to the combined thicknesses of each one of the four water-soluble films 10, 20, 30, 40. The thickness of the linking portion 12 may be determined in the state where all the water-soluble films have already been joined together. A desired multilayer structure of the linking portion may enable obtaining a desired dissolution time.

In addition to the third cavity 11C discussed above, the third water-soluble film 30 may comprise any number of further additional cavities. The total number of cavities provided in the third water-soluble film 30 is not limited.

Further additional water-soluble films can be provided either on top of or below each one of the water-soluble films 10, 20, 30, 40 of FIGS. 11-12.

The process for manufacturing a water-soluble pouch P may comprise superposing the one or more additional cavity on top of the first cavity 11A and/or on top of the second cavity 11B. This type of arrangement is shown in each one of FIGS. 11-12. The arrangement is such that none of the water-soluble films includes any cavities positioned over or below the linking portion 12. The width of the linking portion 12 is thus at least 0.5 cm the entire Z-direction.

Another arrangement is shown on FIG. 13 where the additional cavities (that is, any cavities which are provided in addition to the first and second cavities 11A, 11B) may be superposed on top of the linking portion 12 formed between the first and second cavities 11A, 11B. Such an arrangement is generally not desirable since it makes it difficult/cumbersome or even impossible to close the dispenser drawer's lid D2. Therefore, such arrangement might not be entirely suitable for improving user experience and ease of manipulation with the water-soluble pouches P. Therefore, the arrangement of FIG. 13 is presented as a comparative example.

When at least one additional cavity is provided, the arrangement of the cavities may be such that a distance measured along the second direction Y between any point comprised in the first cavity and any point comprised in the one or more additional cavity superposed thereon, if present, is at least 0.5 cm. At the same time, the arrangement of the cavities may be such that a distance measured along the second direction Y between any point comprised in the second cavity and any point comprised in the one or more additional cavity superposed thereon, if present, is at least 0.5 cm. The one or more additional cavity may be positioned such that the additional cavity does not overlap with the linking portion 12.

The process for manufacturing the water-soluble pouch P may comprise forming the linking portion 12 such that a thickness of the linking portion 12 substantially equals to a sum of thicknesses of the water-soluble films provided. In some examples, each water-soluble film is in direct contact with any adjacent film. This type of arrangement can be seen in FIG. 5, at the bottom of FIG. 11 and in FIG. 12. The arrangement is advantageous for example in that it improves mechanical stability of the linking portion 12. This technical effect might be relevant to ensure that the linking portion 12 is not damaged or does not break when the lid D2 of the dispenser drawer D is closed.

In some examples, due to the sealing process which may partially melt one or more of the first/second films, the thickness of the linking portion 12 may be less than the sum of the thicknesses of the first and second films, e.g. between 60% and 99% of the sum. Alternatively, in other examples, the process of sealing individual water-soluble films may be done by adding solvent (e.g. water) to partially dissolve surfaces of the films. Such process may cause the films to swell and increase their thickness. The thickness of the linking portion 12 may thus be more than the sum of the thicknesses of the first and second films, e.g. between 101% and 120% of the sum.

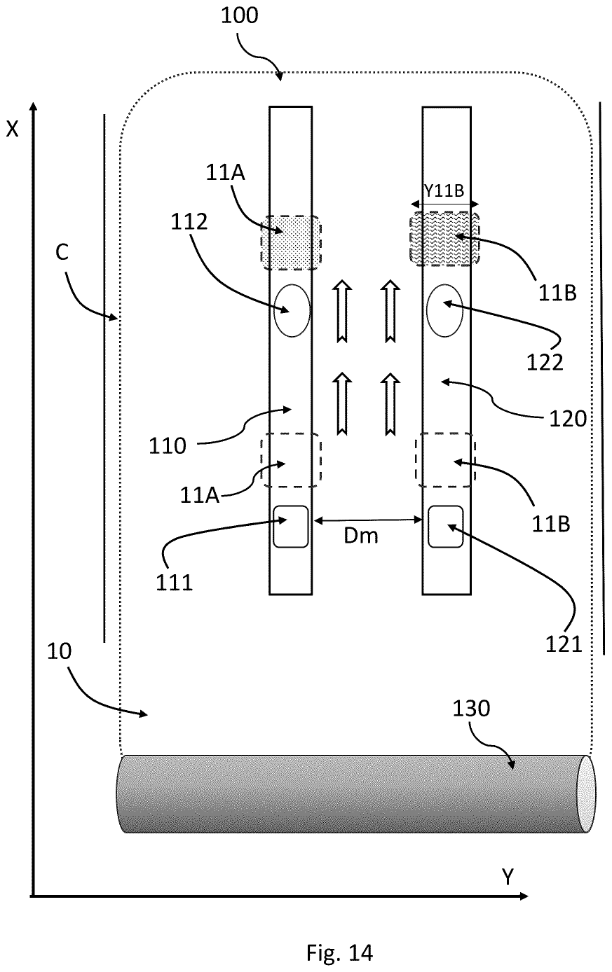

An example system 100 for producing a water-soluble pouch P according to the present disclosure is shown on FIG. 14 in a top view. The system 100 comprises a first pouch-filling line 110 and a second pouch-filling line 120 parallel to and directly adjacent to the first pouch-filling line 110. The system 100 comprises a first film-feeding device 130, which can comprise an unwinding device for unwinding a coil of the first water-soluble film 10. The system 100 comprises a conveyor C receiving the first water-soluble film 10 fed from the first film-feeding device 130 and configured to convey the first water-soluble film 10 along the first direction X. The arrows in the middle of FIG. 14 illustrate the conveying direction. If more than one water-soluble film is provided, the system may comprise a second film-feeding device (not illustrated) or any number of additional film-feeding devices (not illustrated), which can be of the same type of the first film-feeding device 130. The first and second pouch-filling lines 110, 120 extend along the first direction X and comprise respective first and second cavity-forming devices 111, 121, which may be constituted by mold cavities arranged in the conveyor C. One should note that a pouch-filling line may also be called a pouch-filling lane. The first and second cavity-forming devices 111, 121 are configured to respectively form a first and a second cavity 11A, 11B in the first water-soluble film 10. Even though the first and second cavity-forming devices 111, 121 are normally configured to form a plurality of cavities 11 in succession, FIG. 14 only shows two cavities, for simplification. The cavities 11A, 11B are represented by dashed lines indicating that the position of the cavities 11A, 11B is not fixed but is changing in time as the conveyor belt moves.

The first cavity-forming device 111 is separated from the second cavity-forming device 121 at least by a minimum distance Dm along the second direction Y. The minimum distance Dm can be measured as a gap between sides of the cavity forming devices 111, 121 which are facing each other. That is, the distance Dm is measured between a pair of points of the first cavity forming device 111 and the second cavity forming device 121 which are closest to each other along the second direction Y.

The first and second cavity-forming devices 111, 121 can include molds having certain shapes and profiles. The first and second cavities 11A, 11B can be formed by vacuum forming, which includes sucking a water-soluble film into mold. After the water-soluble film is sucked into a mold the water-soluble film can be further pressed into the mold to ensure that the shape and profile of the resulting cavity matches the shape and profile of the mold. In some examples, the water-soluble film can be pre-heated prior to vacuum forming. The pre-heating can be done by use of an infrared lamp under which the film passes prior to its deformation. The pre-heating can also be achieved by a heated roller or any other means which is suitable for heating. As an alternative to vacuum forming, the molds can be pressed against the water-soluble film so as to form a cavity substantially in the shape and profile of the mold.

The second cavity 11B has a second maximum width Y11B along the second direction Y and the ratio of the second maximum width Y11B over the sum of the minimum distance Dm and the second maximum width Y11B can be less than 80%.

$$\frac{Y 11 B}{Dm + Y 11 B} \leq 0.8$$

In some examples, the above ratio Y11B/(Dm+Y11B) can be equal to or less than 70%, equal to or less than 60%, or equal to or less than 50%.

In some examples, the minimum distance Dm between the first cavity-forming device 111 and the second cavity-forming device 121 is in the range of 0.5 to 10 cm, preferably from 1 to 3 cm.

As shown schematically on FIG. 14, the system may comprise a first feeding device 112 and a second feeding device 122 for respectively feeding a first detergent composition into a first cavity 11A and for feeding a second detergent composition into a second cavity 11B.

Each of the feeding devices 112, 122 may be active (ON) for delivering product to the respective cavity 11A, 11B as the cavity 11A, 11B is located below the respective feeding device 112, 122, or inactive (OFF) for interrupting releasing product when a cavity is not located below the respective feeding device 112, 122. In other words, each one of the first feeding-device 112 and the second feeding-device 122 are configured to operate in an ON and OFF state, such that during the ON state the first feeding-device 112 and the second feeding-device 122 are configured to discharge the first detergent composition and the second detergent composition respectively, and such that during the OFF state the first feeding-device 112 and the second feeding-device 122 are configured to not discharge the first detergent composition and the second detergent composition respectively, and the system 100 is configured to activate the ON state of the first feeding-device 112 or the second feeding-device 122 when a first cavity 11A is below the first feeding-device 112 or when a second cavity 11B is below the second feeding-device 122 respectively. The time that the first feeding device 112 spends in the ON state may be also referred to as ON time of the first feeding device 112. The time that the first feeding device 112 spends in the OFF state may be also referred to as OFF time of the first feeding device 112. In the same way, the time that the second feeding device 122 spends in the ON state may be also referred to as ON time of the second feeding device 122, and the time that the second feeding device 122 spends in the OFF state may be also referred to as OFF time of the second feeding device 122.

The feeding devices 112, 122 may or may not be aligned along the X direction, and thus may or may not switch simultaneously between the ON and OFF state or between the OFF and ON state. Also, depending on the shape or size of the respective cavities 11A, 11B, the feeding devices 112, 122 may interrupt or may start feeding detergent product at different times.

The feeding devices 112, 122 may comprise a releasing head or nozzle. The rate of product (volume per unit time) can be regulated to ensure that a cavity is filled with a desired amount of material within the time frame when the cavity 11A, 11B is below the feeding device 112, 122.

The feeding device 112, 122 may comprise a feeding screw (auger) which can have a variable rotation rate, e.g. between 0 rpm (OFF state) and N rpm (ON state), where N and the acceleration between 0 and N are calculated to obtain a desired amount of detergent in the respective cavity 11A, 11B.

An appropriate sensing system (e.g. optical sensor or another adequately chosen sensor) can be provided to ensure the position and/or velocity of the cavity 11A, 11B, with the aim of synchronizing the delivery of detergent with the movement of the cavity 11A, 11B. The conveyor C and the feeding device 112, 122 may be synchronized mechanically or electronically to ensure that no detergent is delivered to the conveyor C in absence of any cavity below the feeding device 112, 122.

As several successive rows of cavities (of successive pouches P) are travelling below the feeding devices 112, 122, the feeding devices 112, 122 may be configured to operate in the ON state for as long as possible. However, it should also be taken into account that it is generally intended to dose the product as fast as possible to minimize powder spillage around the cavities 11A, 11B. Generally, cavities with relatively smaller volume to be dosed (e.g. the smaller cavity 11B) require relatively shorter times in the ON state, while cavities with relatively bigger volume to be dosed require relatively longer times in the ON state. In view of the above considerations, the ratio of the time the feeding device 112 operates in the ON state and the time the feeding device 112 spends in the OFF state may be ⅘. That is, the first feeding device 112 may spend in the ON state approximately 80% of the time it spends in the OFF state. In other examples, the first feeding device 112 may spend in the ON state approximately 400% of the time it spends in the OFF state. That is, the ON time of the first feeding device 112 can be anywhere between 80% and 400% of the OFF time of the first feeding device 112.

Regarding the second feeding device 122, the second feeding device 122 may operate in the ON state approximately 40% of the time it spends in the OFF state. In other examples, the second feeding device 122 may operate in the ON state approximately 100% of the time it spends in the OFF state (the times spent in the ON state and the OFF state are the same). That is, the ON time of the second feeding device 122 can be anywhere between 40% and 100% of the OFF time of the second feeding device 122. For the second feeding device 122, the ON time is thus less than or equal to the OFF time of the second feeding device 122. The ON times for the second feeding device 122 as presented in this paragraph are generally much higher than ON times which could be achieved with other alternative arrangements of the system (such as the systems where the array of cavities would be conveyed along the Y-direction as illustrated in FIG. 2A). According to the above examples, the ratio of time the second feeding device 122 operates in the ON state and time the second feeding device 122 operates in the OFF state can be at least ⅖. The ratio of time the second feeding device 122 operates in the ON state and time the second feeding device 122 operates in the OFF state may also be at least ⅗, or at least ⅘.

For the first feeding device 112, for the ratio of time the first feeding device 112 operates in the ON state and time the first feeding device 112 operates in the OFF state can be at least ⅘. The ratio of time the first feeding device 112 operates in the ON state and time the first feeding device 112 operates in the OFF state may also be at least 1/1, at least 2/1, or at least 3/1.

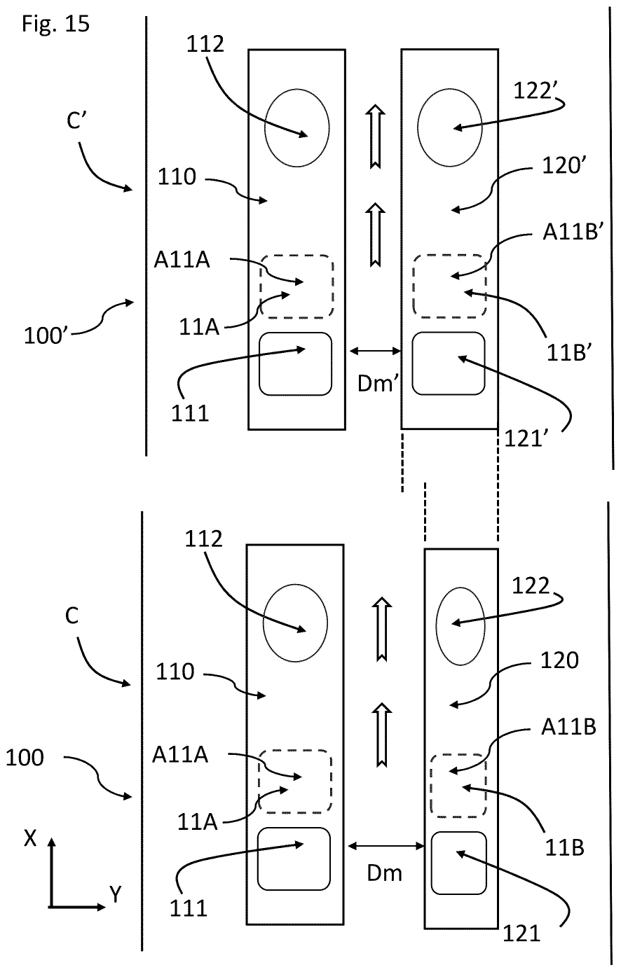

In relation to FIG. 15, the present disclosure also relates to an example method of transforming a first system 100′ for producing a water-soluble pouch P into a second system 100 for producing a water-soluble pouch P, wherein the first system 100′ comprises: a first pouch-filling line 110 extending in a first direction X and comprising a first cavity-forming device 111 for forming a first cavity 11A in a water-soluble film 10, the first cavity 11A having a first surface area A11A, and a second pouch-filling line 120′ directly adjacent to the first pouch-filling line 110 extending in the first direction X and comprising a second cavity-forming device 121′ for forming a second cavity 11B′ in the water-soluble film 10, the second cavity 11B′ having a second surface area A11B′, wherein the second surface area A11B′ is substantially equal to the first surface area A11A. The first system 100′ is suitable for use when each lane, that is each pouch-filling line 110, 120′ is adapted to produce a separate pouch, e.g. when cavities 11A, 11B′ are formed in separated individual pouches. In such a case, the water-soluble film 10 is cut through between the cavities 11A, 11B (the are along the distance Dm′ in FIG. 15). When transforming the first system 100′ to the second system 100 the pouch-filing line 120′ is modified to a pouch-filling line 120 to enable creation of pouches with a linking area using the same conveyor C (that is the conveyor C might the same as the conveyor C′). In such a modified system 100 the pouch P includes both the first cavity 11A and the second cavity 11B and also the linking portion 12 in between the cavities, which means that in such case the water-soluble film is not cut in the area along the distance Dm in FIG. 15.

The method comprises adapting the second cavity-forming device 121 such that the second surface area A11B is comprised between 20 and 80% of the first surface area A11A and such that a minimum distance Dm between a resulting first cavity 11A and a resulting second cavity 11B along a second direction Y substantially perpendicular to the first direction X is increased. The first surface area A11A and the second surface area A11B are defined along the surface of the water-soluble film 10 within the respective cavity 11A, 11B.

The surface areas A11A, A11B of the cavities 11A, 11B can be defined as seen from a top view as illustrated in FIG. 15, i.e., the footprint of the cavity in the XY plane.

The top part of FIG. 15 illustrates a system 100′ which comprises a conveyor C′. The conveyor comprises a first pouch-filling line 110 and a second pouch-filling line 120′. The first and second pouch-filling lines 110, 120′ comprise a first cavity-forming device 111 and a second cavity-forming device 121′, respectively, as well as a first and second feeding devices 112, 122′ for feeding a first detergent composition into a first cavity 11A and for feeding a second detergent composition into a second cavity 11B′. The first cavity-forming device 111 is configured to form first cavities 11A on a first water-soluble film 10. The first cavities 11A have a first surface area A11A, when seen from above. The second cavity-forming device 121′ is configured to form second cavities 11B′ on the first water-soluble film 10. The second cavities 11B′ have a second surface area A11B′, when seen from above. The first and second pouch-filling lines 110, 120′ are separated from one another along the direction Y, transverse to the conveying direction X, by a distance Dm′. In practice, the system 100′ may comprise several pouch-filling lines, of which only two are shown on FIG. 15.

In the system 100′, the surface area A11B′ is substantially equal to the surface area A11A. The distance Dm′ may be too small to allow the system 100′ to produce a pouch as discussed above, or to perform the method as discussed above. One should realize that in some examples a system such as the first system 100′ may be designed to limit platen or pouch-filling line size along the Y-direction compared to the corresponding pouch size along the same direction.

The system 100′ may thus need to be transformed into the system 100 able to perform the method of the present disclosure to obtain a pouch according to the present disclosure. The transformation between the system 100′ and the system 100 may involve an action on the pouch-filling line 120′ while the pouch-filling line 110 remains unchanged. The system 100′ may be a system to produce, for example, pouches comprising a single cavity, for example a pouch comprising the single cavity 11B′.

For example, the cavity-forming device 121′ may be modified into a cavity-forming device 121 allowing to obtain a cavity 11B having a surface area of A11B different from the surface area A11A. In particular A11B may be comprised between 10% and 90% of the surface area A11A, preferably between 20% and 80%, more preferably between 25% and 75%.

This modification allows the distance between the two pouch-filling lines 110, 120 to increase from Dm′ to Dm, without increasing the overall size of the system: the width along direction Y of the conveyor C is the same as the width of the conveyor C′. In such an example, the system 100′ would, in similar conditions, produce twice as many single cavity pouches as the number of pouches as per the present disclosure produced in the same time period by the system 100.

The feeding device 122′ may, or may not, be modified into a feeding device 122 with a narrower nozzle, configured to more appropriately feed a smaller cavity.

In the second system 100, after filling the first and second cavities 11A, 11B the first and second water-soluble films 10, 20 may be sealed through heat sealing and/or solvent sealing. For example, the first and second water-soluble films can be sealed by solvent sealing wherein the sealing solvent is water. In some examples, the sealing solvent is applied to either or both of the water-soluble films through contact application, such as by using a pre-wetted felt role or non-contact application such as spray sealing.

In the second system 100, the pouches P may be cut from the films in X-direction by a cutting roller. Further, the pouches P may be cut in Y-direction by a rotary cutting blade which may rotate at constant or variable speed.

In the second system 100, the individually separated pouches P may be transported to a packing line to pack the pouches P in a plastic- or paper-based bag or container.

At least one of the water-soluble films used in the pouch P can be printed prior to being wound on the winding roll of the film-feeding device 130. In some examples, at least one of the water-soluble films used in the pouch P can be printed anywhere in between the unwinding roll of the film-feeding device 130 and the conveyor C. In other examples, at least one of the water-soluble films used in the pouch P can be printed at any point while on the conveyor or after the pouch P has been completed. For example, at least one of the water-soluble films can be printed in between the unwinding roll of the film-feeding device 130 and the conveyor C through passing the film under a printing station. In some examples, a combination of flexographic printing stations printing a combination of colors can be used. The film may be printed on the inside of the water-soluble film, that is on the side facing the enclosed detergent composition.

In some examples, the second system 100 may include a station where the pouches P can be dusted post the pouch-making process.

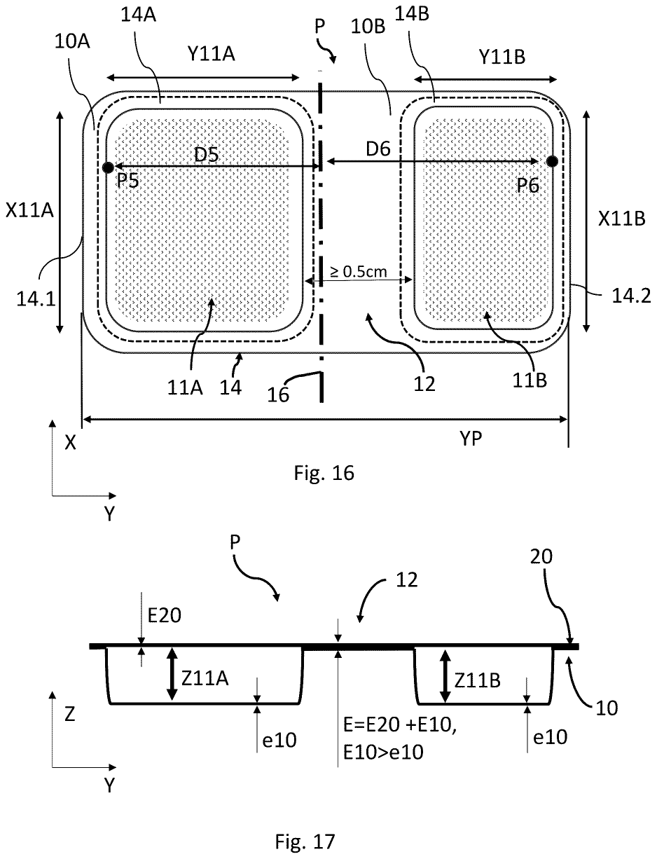

FIG. 16 shows an example of a water-soluble pouch P according to the present disclosure. The pouch P may have some or all of the properties discussed above in relation to FIGS. 1 to 15. The cavities 11A, 11B may contain detergent as detailed above or below.

The pouch P comprises two cavities 11A, 11B separated from one another by a linking portion 12. The contour 14 of the pouch P may be substantially polygonal, e.g., rectangular or square. The contour 14 is obtained from a film or an array (as shown on FIG. 2), by cutting through the film(s) to subdivide the array of cavities into series of pouches P. The pouch P may have a maximum width YP along the second direction Y. The maximum width YP of the pouch P is defined as a distance of two points included in the pouch P which are furthest from each other along the second direction Y. One or more pairs of such points may exist depending on the shape of the pouch.

In this example, a center line 16, parallel to direction X, divides the pouch P into two substantially equal portions. A first portion contains the first cavity 11A and a second portion contains the second cavity 11B.

The dimensions of the first and second cavities 11A, 11B along directions X and Y are respectively noted X11A, X11B, Y11A and Y11B. The dimension X11A corresponds to the first maximum length as explained above with reference to FIGS. 4 and 10. The dimension X11B corresponds to the second maximum length as explained above with reference to FIGS. 4 and 10. The dimension Y11A corresponds to the first maximum width as explained above with reference to FIGS. 4 and 10. The dimension Y11B corresponds to the second maximum width as explained above with reference to FIGS. 4 and 10.

As can be seen on FIG. 16, the second cavity 11B may be elongated along the direction X, i.e. X11B>Y11B.

The second maximum length X11B of the second cavity 11B may be comprised between 70% and 130% of the first maximum length X11A of the first cavity 11A, preferably between 90% and 110% of the first maximum length X11A of the first cavity 11A.

The first cavity 11A, the second cavity 11B and the linking portion 12 are aligned along direction Y. In other words, at least some points of the first and second cavity 11A, 11B and of the linking portion 12 share a common X coordinate. This can also be understood as: at least one same line parallel to axis Y can pass through at least one point of the first cavity 11A, at least one point of the linking portion 12 and at least one point of the second cavity 11B.

As discussed already above, the cavities 11A, 11B are distanced from each other by at least 0.5 cm. More particularly, the distance measured along the second direction Y between any point comprised in the first cavity 11A and any point comprised in the second cavity 11B is at least 0.5 cm. In some examples, the distance can be at least 0.7 cm, at least 1 cm, at least 2 cm, at least 5 cm or at least 10 cm.

The center line 16 divides the pouch P into a first area 10A receiving the first cavity 11A and a second area 10B receiving the second cavity 11B. The first area 10A extends from a first end 14.1 of the pouch P to the center line 16 and the second area 10B extends from the center line 16 to a second end 14.2 of the pouch P, opposite the first end 14.1 in the direction Y.

Points P5 and P6 image the points of the cavities 11A, 11B that are positioned the furthest away from the center line 16 along the direction Y. In some examples, the distance D5 between point P5 and the center line 16 is equal to the distance D6 between point P6 and the center line 16.

FIG. 16 also shows a first and a second peripheral seal areas 14A, 14B extending from the respective cavity 11A, 11B, to a dashed line. The peripheral seal areas 14A, 14B can extend up to the peripheral edge of the contour 14.

The peripheral seal area 14A and/or 14B may have a width (perpendicular to the contour of the cavity) that is comprised between 0.5 and 10 mm, preferably between 1 and 5 mm.

FIG. 17 shows a cross-section of the pouch P of FIG. 16. One can see on this example that the second film 20 is substantially of a planar structure.

The depth of the cavities 11A, 11B is noted Z11A and Z11B. The parameter Z11A represents the maximum depth along the third direction Z, which corresponds to maximum distance between any two points comprised in the first cavity 11A and measured along the third direction Z. In the same way, parameter Z11B represents the maximum depth along the third direction Z, which corresponds to maximum distance between any two points comprised in the second cavity 11B and measured along the third direction Z. The two cavities 11A, 11B can share a common maximum depth. In a variant, the second cavity 11B has the second maximum depth Z11B that is less than the first maximum depth Z11A, preferably at least 20% less than the first maximum depth Z11A. In an alternative, the second cavity 11B has the second maximum depth Z11B that is more than the first maximum depth Z11A, preferably at least 20% more than the first maximum depth Z11A.

The thickness E20 of the second film 20 may be substantially constant/homogeneous. The thickness of the first film may be smaller (e10) in the cavities 11A, 11B and may be greater (E10>e10) in the linking portion 12, for example due to thermoforming of the film 10 to form the cavities 11A, 11B. The total thickness E in the linking portion 12 may be more than the sum of E20 and e10.

As used in this specification and the claims that follow, the articles “a”, “an”, and “the” include singular and plural references unless the context clearly dictates otherwise. As such, the terms “a” or “an”, “one or more” and “at least one” can be used interchangeably herein. Thus, for example, “a component” may include one or more components unless the reference is specifically indicated as being singular.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for making a water-soluble pouch, the process comprising:
providing a first water-soluble film;
conveying the first water-soluble film along a first direction;
forming a first cavity and a second cavity in the first water-soluble film;
while forming the first and second cavities, separating the first cavity from the second cavity by a linking portion along a second direction, wherein the second direction is substantially perpendicular to the first direction,
wherein a distance measured along the second direction between any point comprised in the first cavity and any point comprised in the second cavity is at least 0.5 cm,
wherein the first cavity has a first maximum length along the first direction and a first maximum width along the second direction,
wherein the second cavity has a second maximum length along the first direction and a second maximum width along the second direction, and an aspect ratio between the second maximum length and the second maximum width is at least 1:1; and
filling the first cavity and the second cavity with at least a first detergent composition and at least a second detergent composition respectively.

2. The process of claim 1, further comprising:
providing a second water-soluble film; and
covering the first water-soluble film with the second water-soluble film, thereby sealing the filled first cavity and the filled second cavity.

3. The process of claim 1, further comprising dividing at least one of the first cavity and the second cavity into at least two separate compartments.

4. The process of claim 1, further comprising:
providing one or more additional water-soluble film;
forming one or more additional cavities in at least one of the one or more additional water-soluble films; and
filling the one or more additional cavities with one or more additional detergent compositions,
whereby the provided water-soluble films are superposed.

5. The process of claim 4, further comprising superposing the one or more additional cavities on top of the first cavity and/or on top of the second cavity.

6. The process of claim 1, further comprising forming the linking portion such that a thickness of the linking portion substantially equals to a sum of thicknesses of the water-soluble films provided.

7. A system for producing a water-soluble pouch comprising:
a first pouch-filling line;
a second pouch-filling line parallel to and directly adjacent to the first pouch-filling line;
a first film-feeding device; and
a conveyor receiving a first water-soluble film fed from the first film-feeding device and configured to convey the first water-soluble film along a first direction,
wherein the first and second pouch-filling lines extend along the first direction and comprise respective first and second cavity-forming devices configured to respectively form a first and a second cavity in the first water-soluble film, wherein the first cavity-forming device is separated from the second cavity-forming device at least by a minimum distance along a second direction, wherein the second direction is substantially perpendicular to the first direction, and
wherein the second cavity has a second maximum width along the second direction and the ratio of the second maximum width over the sum of the minimum distance and the second maximum width is less than 80%.

8. The system according to claim 7, wherein the minimum distance between the first cavity-forming device and the second cavity-forming device is in the range of 1 to 3 cm.

9. The system according to claim 7, wherein:
the first and second pouch-filling lines respectively comprise a first feeding-device and a second feeding-device for feeding a first detergent composition into a first cavity and for feeding a second detergent composition into a second cavity,
each one of the first feeding-device and the second feeding-device are configured to operate in an ON and OFF state, such that during the ON state the first feeding-device and the second feeding-device are configured to discharge the first detergent composition and the second detergent composition respectively, and such that during the OFF state the first feeding-device and the second feeding-device are configured to not discharge the first detergent composition and the second detergent composition respectively,
the system is configured to activate the ON state of the first feeding-device or the second feeding-device when a first cavity is below the first feeding-device or when a second cavity is below the second feeding-device respectively, and
the ratio of time the second feeding device operates in the ON state and time the second feeding device operates in the OFF state is at least ⅖.

10. A method of transforming a first system for producing a water-soluble pouch into a second system for producing a water-soluble pouch;
wherein the first system comprises:
a first pouch-filling line extending in a first direction and comprising a first cavity-forming device for forming a first cavity in a water-soluble film, the first cavity having a first surface area; and
a second pouch-filling line directly adjacent to the first pouch-filling line extending in the first direction and comprising a second cavity-forming device for forming a second cavity in the water-soluble film, the second cavity having a second surface area,
wherein the second surface area is substantially equal to the first surface area, the method comprising:
adapting the second cavity-forming device such that the second surface area is comprised between 10 and 90% of the first surface area and such that a minimum distance between a resulting first cavity and a resulting second cavity along a second direction substantially perpendicular to the first direction is increased,
wherein the first surface area and the second surface area are defined along the surface of the water-soluble film within the respective cavity.

11. A water-soluble pouch comprising:
a first cavity formed in a first water-soluble film;
a second cavity formed in the first water-soluble film;
a second water-soluble film sealing the first and the second cavities; and
a linking portion formed at least from a portion of the first and of the second water-soluble films separating the first cavity from the second cavity,
wherein the second cavity has an elongated aspect ratio along a first direction that is substantially perpendicular to a second direction,
wherein the first cavity, the second cavity and the linking portion are aligned along the second direction,
wherein a distance measured along the second direction between any point comprised in the first cavity and any point comprised in the second cavity is at least 0.5 cm, and
wherein the second water-soluble film has a substantially planar structure.

12. The water-soluble pouch according to claim 11, wherein:
the water-soluble pouch has a maximum width along the second direction and is divided by a center line extending along the first direction and located substantially in the middle of the maximum width of the water-soluble pouch,
the first cavity is located in a first area extending between a first end of the water-soluble pouch along the second direction and the center line and the second cavity is located in a second area extending between a second end of the water-soluble pouch along the second direction and the center line,
the second end of the water-soluble pouch is opposite to the first end of the water-soluble pouch, and
a distance along the second direction between the center line and a point of the first cavity located farthest from the center line along the second direction is substantially the same as a distance along the second direction between the center line and a point of the second cavity located farthest from the center line along the second direction.

13. The water-soluble pouch according to claim 11, wherein:
the first cavity has a first maximum length along the first direction and the second cavity has a second maximum length along the first direction, and
the second maximum length of the second cavity is between 90% and 110% of the first maximum length of the first cavity.

14. The water-soluble pouch according to claim 11, wherein the first area includes the first cavity and a first peripheral seal area surrounding the first cavity,

15. The water-soluble pouch according to claim 14, wherein the width of the peripheral seal area is in the range of 1 to 5 mm.

16. The water-soluble pouch according to claim 11, wherein an average thickness of a portion of the first water-soluble film forming the first cavity and the second cavity is smaller than a thickness of the first water-soluble film forming the linking portion.

17. The water-soluble pouch according to claim 16, wherein a thickness of the second water-soluble film is substantially homogeneous.
